(19) United States
(12) Patent Application Publication
(10) Pub. No.: US 2024/0402345 A1
(43) Pub. Date: Dec. 5, 2024

(54) METHOD FOR IMPLEMENTING A LIDAR DEVICE WITH DESCRIPTORS EMPLOYING DISTANCE EVALUATION

(71) Applicant: Continental Autonomous Mobility Germany GmbH, Ingolstadt (DE)

(72) Inventors: Niklas PETTERSSON, Toulouse (FR); Thomas MENEYROL, Toulouse (FR); Laure BAJARD, Toulouse (FR)

(21) Appl. No.: 18/697,759

(22) PCT Filed: Oct. 21, 2022
(86) PCT No.: PCT/EP2022/079357

§ 371 Date: Apr. 2, 2024

(30) Foreign Application Priority Data
Oct. 21, 2021 (FR) FR2111200

(51) Int. Cl. G01S 17/931; G01S 7/48

(52) U.S. Cl. CPC G01S 17/931; G01S 7/4802; G01S 7/4808

(57) ABSTRACT

A method for using a light detection and ranging (LIDAR) device in a motor vehicle, including determining a first descriptor; determining a second descriptor; identifying corresponding environment signatures in the first descriptor and the second descriptor. Each of the indicators of an environment signature being configured to take a value representative of one of the following four states: distance away outside of a first predetermined range of distances; distance away in a lower segment of said first predetermined range of distances; distance away in an upper segment of said first predetermined range of distances; distance away substantially equal, to within a predetermined factor.

### CROSS REFERENCE TO RELATED APPLICATIONS

This application is the U.S. National Phase Application of PCT International Application No. PCT/EP2022/079357, filed Oct. 21, 2022, which claims priority to French Patent Application No. 2111200, filed Oct. 21, 2021, the contents of such applications being incorporated by reference herein.

### TECHNICAL FIELD

The invention relates to the field of motor vehicles and more specifically relates to LIDAR devices employed in motor vehicles.

### BACKGROUND OF THE INVENTION

LIDAR (Light Detection And Ranging) devices are devices that allow objects and other elements in the environment of a motor vehicle to be detected and the distance between the vehicle and the detected objects to be measured.

LIDAR devices employed in motor vehicles generally comprise a light emitter, which is designed to emit incident light rays, i.e., toward the environment of the vehicle. They also comprise a photodetector, which is designed to receive in return the light rays reflected by the objects located in the environment of the vehicle. By measuring the elapsed times between the emission and the reception of the light rays, and by taking into account the speed of propagation of light, LIDAR devices allow the objects surrounding the vehicle to be detected and the distance of these objects from the vehicle to be determined.

LIDAR devices are generally employed in motor vehicles to assist the driver, for example, in the case of certain maneuvers or to implement cruise control systems. LIDAR devices are also used in autonomous vehicles, i.e., vehicles capable of driving autonomously without a human driver. In particular, owing to their precision, LIDAR devices are indispensable in driving systems for autonomous vehicles and allow these vehicles to perceive their surroundings, which is a crucial operation to allow the vehicle to adapt its trajectory to the environment.

The reliability of a LIDAR device, when it is used in a motor vehicle, is a guarantee of safety. Moreover, when a LIDAR device is employed in an autonomous vehicle, this reliability is critical since the safety of the passengers and of the environment of the vehicle is based on this reliability in particular.

LIDAR devices, when they are employed in a vehicle, allow successive sequences of the external environment to be detected and allow the same object present in these various sequences to be matched. The LIDAR device thus allows the vehicles to perceive the movements of the objects surrounding the vehicle, with these movements being linked to the relative movement of the vehicle and/or to the specific movement of these objects. Matching objects between various sequences detected by the LIDAR device thus allows the movement of an object from one sequence to another to be detected and quantified. This recognition of the movement is the basis of the use of LIDAR devices in motor vehicles, and more specifically in autonomous vehicles, in particular to ensure the safety of the vehicle and of its environment, by detecting, for example, any movement of an object and specifically those that could interfere with the vehicle.

LIDAR devices are known that are employed in motor vehicles and are provided with means for matching objects.

The LIDAR devices of the prior art generally determine a point cloud for each detected sequence of the environment, with these point clouds representing the environment of the vehicle at a given instant. For each of these point clouds, complex algorithms are generally employed to detect, within the point cloud, singularities called “key points”. After various key points are detected in the various sequences, these algorithms carry out identification computations allowing the presence of the same key point in the various sequences to be recognized.

The LIDAR devices of the prior art require significant computation resources for implementing these complex algorithms and also require the use of high-resolution photodetectors to enable precise and efficient detection of the key points.

In the LIDAR devices of the prior art, increasing performance and detection safety necessarily involves increasing the resolution of the photodetector and increasing the computation power.

### SUMMARY OF THE INVENTION

An aim of the invention is to improve the methods of the prior art.

To this end, an aspect of the invention concerns a method for using a light detection and ranging (LIDAR) device in a motor vehicle, comprising the following steps:
emitting incident light rays from the motor vehicle toward its external environment;
receiving in return reflected light rays on a photodetector of the motor vehicle;
associating a value representing a quantity relating to the reflected light ray with each cell of the photodetector that receives a reflected light ray.

This method further comprises the following steps:
a step of determining a first descriptor comprising a first set of environment signatures for a selection of cells of the photodetector, with this first descriptor corresponding to a first sequence for receiving reflected light rays;
a step of determining a second descriptor comprising a second set of environment signatures for a selection of cells of the photodetector, with this second descriptor corresponding to a second sequence for receiving reflected light rays;
a step of identifying corresponding environment signatures in the first descriptor and the second descriptor;
an environment signature of a particular cell of the photodetector being defined as a set of distance indicators, each associated with one cell of a predetermined pattern of environment cells of said particular cell, each of said distance indicators being adapted to take a value representative of one of the following four states:
the cell concerned is associated with a distance away which is outside a first predetermined range of distances relative to the distance away that is associated with said particular cell;
the cell concerned is associated with a distance away which is located in a lower segment of said first predetermined range of distances;
the cell concerned is associated with a distance away which is located in an upper segment of said first predetermined range of distances;
the cell concerned is associated with a distance away which is substantially equal to the distance away that is associated with said particular cell, to within a predetermined factor.

The term “descriptor” in this case encompasses a unique descriptor or a list of descriptors.

Such a method for using a LIDAR device is based on simple operations that require limited computation resources. In addition, this method can be implemented with LIDAR devices provided with low-resolution photodetectors, while ensuring maximum detection safety of the objects in the environment of the vehicle and the matching thereof in order to identify the movement of these objects.

An aspect of the invention counters the tendency to increase the resolution of the photodetectors and the computation resources, as encountered in the prior art, allowing detection to be improved in terms of performance and of safety, while reducing the resolution requirements of the photodetector as well as its computation power.

Indeed, an aspect of the invention is not based on complex operations for identifying “key points” in the sequences detected by the photodetector, but rather on a general characterization of these various sequences by virtue of the sets of environment signatures. The simple and unique character of the environment signatures forming the set of signatures considerably reduces the resources necessary for computing the matching step.

An aspect of the invention thus allows simple and robust LIDAR devices to be used that are provided with low-resolution photodetectors. These LIDAR devices thus comply with automotive standards for low-cost production and with a high reliability level, which was not the case with the LIDAR devices of the prior art, the footprint, the cost and the reliability level of which were not compatible with the automobile production standards.

The method according to an aspect of the invention performs particularly well in the detection of objects from one sequence to another, even if these objects have a uniform surface, and/or if these objects are moving either toward or away from the detection device. The method therefore detects the outlines of objects as well as the bodies of these uniform objects, even when they are moving. In other words, the method according to an aspect of the invention may be used to detect more objects than the prior art, with fewer resources in terms of optical equipment and computing capacity.

The method according to an aspect of the invention can comprise the following additional features, alone or in combination:
during the step of determining the first descriptor, the selection of cells comprises only cells that are associated with a distance away; and, during the step of determining the second descriptor, the selection of cells comprises only cells that are associated with a distance away;
the first descriptor and the second descriptor are each determined by the following operations, executed sequentially for each particular cell of the selection of cells: a first operation of determining the environment signature of the particular cell; an operation of adding this environment signature of the particular cell to the set of environment signatures, if the set of environment signatures does not comprise any environment signature identical to this environment signature of the particular cell; an operation of adding this environment signature of the particular cell to the set of environment signatures, this environment signature being associated with a distinctive element, if the set of environment signatures already comprises an environment signature identical to this environment signature of the particular cell;
said distinctive element is a value of luminous intensity relating to the particular cell;
the predetermined pattern of environment cells, used to determine the environment signature of a particular cell, is made up of a predetermined number of cells framing this particular cell according to a predetermined pattern of a relative arrangement of the environment cells relative to the particular cell;
the set of indicators, used to determine the environment signature of a particular cell, is formed by a set of binary numbers each assigned to a cell of the predetermined pattern of environment cells;
each of said binary numbers comprises two bits encoding the four values representing said indicators;
the binary numbers are assigned to each cell of the predetermined pattern of environment cells of the particular cell, in the following manner:
assigning a first binary number to the environment cell if the latter is associated with a distance away that is outside said first predetermined range;
assigning a second binary number to the environment cell if the latter is associated with a distance away that is located in the lower segment of said first predetermined range;
assigning a third binary number to the environment cell if the latter is associated with a distance away that is located in the upper segment of said first predetermined range;
assigning a fourth binary number to the environment cell if the latter is associated with a distance away that is substantially equal, to within the predetermined factor, to the distance away that is associated with said particular cell;
said predetermined value is weighted, for each environment cell, by the distance separating this environment cell from the particular cell;
said predetermined range of distances and the predetermined factor have values, for each environment cell, that are dependent on the placing of the particular cell on the sensor;
the environment signatures, each associated with a cell of the predetermined pattern of environment cells, are each arranged as a word made up of the binary numbers arranged in a predetermined order relative to the predetermined pattern of environment cells;
during the step of associating a value representing a quantity relating to the reflected light ray with each cell of the photodetector that receives a reflected light ray, the representative value is a distance away, the distance away being defined as a value representing the distance between the cell and an object returning said reflected light ray;
the method comprises a step of matching, in which each environment signature of the first descriptor is compared with each environment signature of the second descriptor;
in the matching step, a dissimilarity value is determined for each pair of environment signatures, the pairs of environment signatures considered to be matching being those whose dissimilarity value is lowest;
said dissimilarity value is determined as follows:
a maximum dissimilarity value for the pairs of environment signatures comprising, on the one hand, an environment signature relating to a distance away that is outside said first predetermined range, and comprising, on the other hand, an environment signature relating to a distance away located within this first predetermined range;
a median dissimilarity value for the pairs of environment signatures comprising, on the one hand, an environment signature relating to a distance away that is located in the lower segment of the first predetermined range, and comprising, on the other hand, an environment signature relating to a distance away that is located in the upper segment of the first predetermined range;
a minimum dissimilarity value for the pairs of environment signatures comprising, on the one hand, an environment signature relating to a distance away that is located in the lower segment or in the upper segment of the first predetermined range, and comprising, on the other hand, an environment signature relating to a distance that is substantially equal to the distance away that is associated with said particular cell, to within the predetermined factor.

### BRIEF DESCRIPTION OF THE DRAWINGS

Other features, aspects, and advantages of the invention will become apparent from the following non-limiting description, with reference to the appended drawings, in which:

FIG. 1 illustrates the steps of the method according to an aspect of the invention;

FIG. 2 illustrates the steps of generating a descriptor within the method of FIG. 1;

FIG. 3 schematically shows a portion of a photodetector of the LIDAR device used by the method according to an aspect of the invention;

FIG. 4 illustrates the first predetermined range of distances used by the method according to an aspect of the invention;

FIG. 5 illustrates the generation of an environment signature according to an aspect of the invention;

FIG. 6 schematically shows an environment signature according to an aspect of the invention;

FIG. 7 is similar to FIG. 3 for a first variant;

FIG. 8 is similar to FIG. 3 for a second variant.

### DETAILED DESCRIPTION OF THE PREFERRED EMBODIMENTS

The method according to an aspect of the invention allows a LIDAR device to be used in a motor vehicle to perceive the environment of the vehicle by detecting an optical flow identifying the movement of the objects in the environment of the vehicle. This method can be implemented with a low-resolution LIDAR device that is provided with basic computation means. This low resolution is, for example, 128×32 cells for the photodetector of the LIDAR device. Photodetectors generally comprise a photosensitive plate formed by an array of elementary sensors, made up of photodiodes, for example. Each cell of the photodetector, also called a “pixel”, forms an elementary detection element.

In addition to this low resolution of 128×32 cells, the photodetector can also comprise a wide-angle lens, with each cell of the photodetector thus detecting the light rays corresponding to a large surface in the image of the environment of the vehicle (for example, from 1 to 3 m², 20 m away from the vehicle, per cell of the photodetector).

The composition of a LIDAR device is known per se and will not be described in further detail herein. It simply should be noted that a LIDAR device comprises a light source designed to emit light pulses toward the environment of the vehicle, and a photodetector formed by an array of elementary cells designed to receive and detect the light rays reflected on the objects surrounding the vehicle, so as to determine a point cloud associating, for example, a distance away from each object in the environment.

The method is thus initially used with the conventional steps of operating a LIDAR device:
emitting incident light rays from the motor vehicle toward its external environment;
receiving in return reflected light rays on a photodetector of the motor vehicle;
associating a value representing a quantity relating to the reflected light ray with each cell of the photodetector that receives a reflected light ray.

In the examples described herein, the value representing a quantity relating to the reflected light ray is a distance away, which is defined as a value representing the distance between the cell and an object returning said reflected light ray. This value representing a quantity relating to the reflected light ray can be supplemented, for example, by the intensity of the reflection, the reflectivity of the surface of an object, or any other quantity that can be detected by the LIDAR device.

The distance away is computed by the LIDAR device based on the travel time of each light ray starting in the form of an incident ray and returning, after reflection on an object, in the form of a reflected ray. The distance away corresponds to the distance between this object and the cell of the photodetector receiving the reflected light ray.

The LIDAR device thus has successive sequences, in which a light pulse is emitted and then collected by the photodetector. These successive sequences correspond to photos of the environment. The sequence of these successive sequences forms an optical flow. The method allows the movements in the successive sequences to be identified, so that the movement of objects, for example, between the various sequences can be analyzed and quantified in order to allow, in the present example, an autonomous vehicle to perceive its external environment and to adapt its driving thereto.

To this end, the method will consider each of the sequences of the optical flow separately, and will compare these sequences in pairs in order to evaluate the movements between two consecutive sequences.

In the present example, the implementation of the method will be described simply for two successive sequences, with it being understood that this elementary method can be implemented continuously for all the successive sequences forming an optical flow.

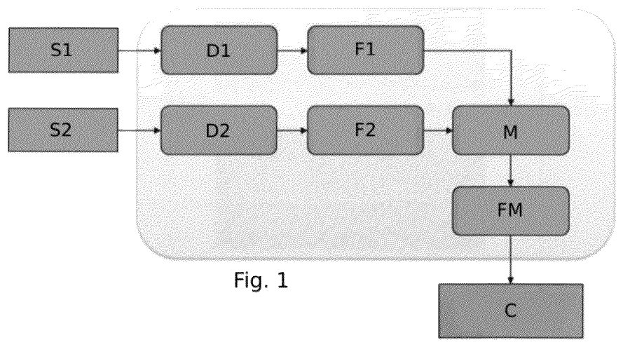

FIG. 1 schematically illustrates the implementation of the method for two successive sequences, i.e., for two environment images each producing a point cloud relating to the objects outside the vehicle.

In FIG. 1, the LIDAR device 1 is schematically shown as containing the various steps of the method. The rectangle S1 corresponds to a first sequence, in which the LIDAR device 1 acquires a point cloud corresponding to a first scene of the environment of the vehicle. The rectangle S2 for its part corresponds to the acquisition of a second sequence immediately following the acquisition of the first sequence S1.

Following the acquisition of the second sequence S2, the LIDAR device 1 thus has two point clouds, each corresponding to the image of a sequence S1, S2.

The aim of the method is to detect the movements performed between the sequence S1 and the sequence S2. This evolution between the sequence S1 and the sequence S2 will allow the movements seen from the vehicle to be determined.

According to FIG. 1, the data originating from the first sequence S1 will initially undergo a step of determining a first descriptor D1, then of filtering F1 this descriptor D1. The data originating from the second sequence S2 also undergoes the same processing involving determining a second descriptor D2 and filtering F2 this descriptor.

The method then performs, on the basis of these two filtered descriptors, a step of matching M, then of filtering FM this matching. These filtered matches C then can be used by the LIDAR device, or other elements for controlling the autonomous vehicle, to enhance the detection of the objects, for example, or to be able to analyze its own movement or the movements of the objects identified by another method.

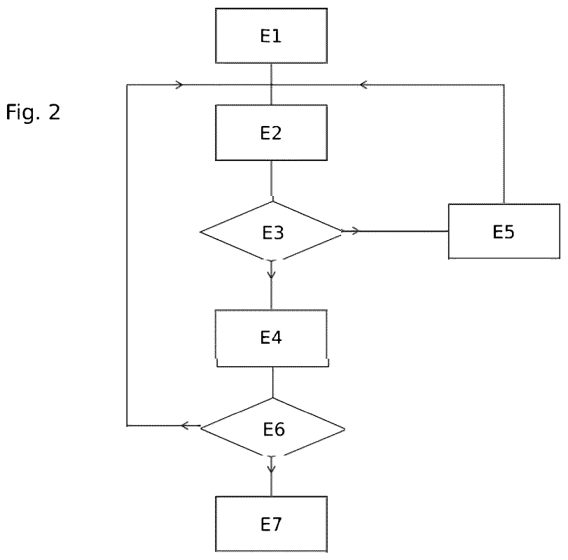

FIG. 2 is a diagram illustrating the steps of determining a descriptor D1, D2 for each of the sequences S1, S2 in further detail.

During the step of determining a descriptor, on the basis of the point cloud corresponding to a sequence S1, S2, the method will initially identify the usable cells of the photodetector (step E1). In this case, the usable cells of the photodetector are defined as the cells that actually received a light ray reflected by the presence of an object in the external environment. The cells of the photodetector that do not receive a reflected light ray do not detect the presence of an object and in this case are excluded from the cells considered to be usable. This is the case when the incident light ray does not find an object on its path and, since it is not reflected, therefore does not return to the photodetector. Similarly, an external method may have marked certain cells as unusable for various reasons, such as identifying a defect in the cell. Determining a descriptor D1, D2 thus applies only to the cells of the photodetector that have received a reflected light ray and/or that have not been marked as unusable by any external method. These usable cells form a selection of cells of the photodetector.

In the following step E2, the method determines an environment signature for one of the cells of the selection. The method returns to this step E2 so that this step E2 and the following steps are sequentially applied to each of the cells of the selection. Furthermore, the selection of cells can be limited to the usable cells that are not located on the edge of the plate of the photodetector.

Preferably, the usable cells forming the selection, which therefore will each undergo the steps E2 and the following steps, can be processed in order, for example, starting with the cell in the upper left end of the plate of the photodetector, then continuing, for each iteration of step E2 and the following steps, with a neighboring cell.

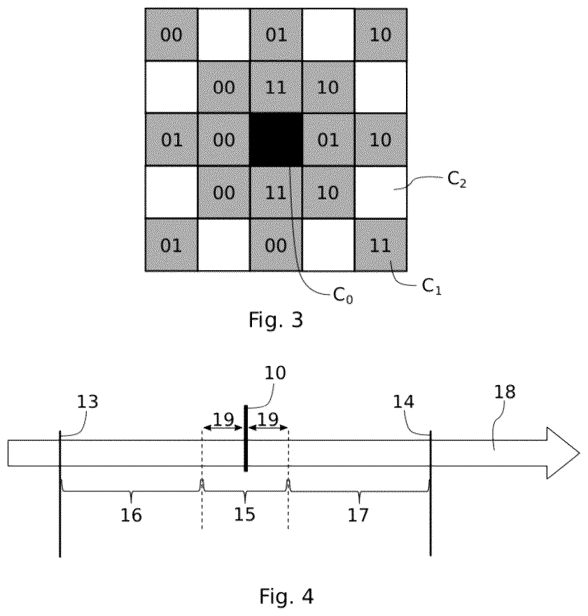

Step E2 is initially carried out for a first cell of the selection. Determining an environment signature for this first cell in this case involves assigning a binary number to each of the cells that surround said cell according to a predetermined pattern. In order to simplify the vocabulary of the present application, the cell for which an environment signature is being determined is called, throughout the present application, “particular cell” and the cells surrounding a particular cell according to a predetermined pattern are called “environment cells”. Determining an environment signature will be described in further detail hereafter with reference to FIGS. 3 to 8.

An environment signature is composed of a sequence of binary numbers relating to the environment cells of the particular cell.

The method then proceeds to a step E3 corresponding to the determination of this environment signature relating to a particular cell. Step E4 then consists in adding this environment signature to a list forming a set of environment signatures. With regard to the first iteration of step E2, i.e. for the first particular cell concerned, no environment signature has been previously recorded, and the environment signature of this iteration is therefore added (step E4) to all the environment signatures. If, in the subsequent iterations of step E2 and the following steps, targeting the following cells of the selection, a new environment signature is identified as identical to a signature already present in the set of environment signatures, the new signature in question is then also added, in step E5, to the set of environment signatures, but this time a distinctive element is also memorized. In the present example, this distinctive element is, for example, a value of luminous intensity of the particular cell, or an average of the luminous intensities of the particular cell and of its environment cells. This distinctive element will be used to separate two environment signatures that are identical among the set of environment signatures.

The method then loops back to step E2 to start a new iteration with the next cell in the selection, which is then treated as the new particular cell.

After step E4 of adding a new signature to the set of signatures, the method proceeds to step E6, which determines whether the last cell of the selection has been reached. Step E6 thus determines whether all the cells of the selection have definitely undergone an iteration of the steps E2 and of the following steps. If, during step E6, the cell in question is not the last cell of the selection, the method loops back to step E2, which is then implemented for the following cell in the selection, treated as the new particular cell.

If, during step E6, the cell in question is actually the last cell of the selection, this means that the iterations of steps E2 and the following steps have been carried out for the entire selection of cells, and the method then proceeds to step E7, in which the list of environment signatures is produced.

Determining the environment signature of a particular cell (step E2) will now be described in further detail with reference to FIGS. 3 and 4.

FIG. 3 shows a portion of the matrix plate forming the photodetector. This matrix is made up of elementary photosensitive cells (also called “pixels”). On the portion illustrated in FIG. 3, a central cell C₀ is shown surrounded by other cells C₁ (shown in gray) and C₂ (shown in white). In this example, cell C₀ is the particular cell for which an environment signature is being determined.

The gray cells C₁ are environment cells of the cell C₀, i.e., cells arranged in a predetermined pattern (visible in gray) around the particular cell C₀.

Determining the environment signature of the particular cell C₀ will involve assigning a binary number to each of the cells C₁ of the pattern. The other cells, such as the cells C₂ shown in white in FIG. 3, as well as all the other cells of the photodetector (which are not shown on the photodetector portion visible in FIG. 3) are not taken into account for determining the environment signature of the particular cell C₀.

In order to determine which binary number is to be assigned to an environment cell C₁, the principle involves, in the present example:
assigning a first binary number if the distance away associated with this environment cell C₁ is very far from the distance away associated with the particular cell C₀;
assigning a second binary number if the distance away associated with this environment cell C₁ is relatively close to the distance away associated with the particular cell C₀, while being smaller;
assigning a third binary number if the distance away associated with this environment cell C₁ is relatively close to the distance away associated with the particular cell C₀, while being greater;
assigning a fourth binary number if the distance away associated with this environment cell C₁ is substantially equal to the distance away associated with the particular cell C₀.

In the present example, these four possibilities for the binary number of an environment cell C₁ are determined by the comparison between the distance away associated with the particular cell C₀ and the distance away associated with the environment cell C₁ concerned. FIG. 4 schematically shows the positioning of these distances away: an arrow 18 illustrates a scale of distances away, onto which may be placed any distance measured by the device by means of the reflected light rays reaching a cell of the photodetector. On this scale, the distance away associated with the particular cell C₀ is denoted by a marker 10. The marker 10 therefore corresponds to a distance between the photodetector and an object that reflects the light rays onto the particular cell C₀. Around this marker 10 there is defined an equality range 15 in which a distance away is considered to be substantially equal to the distance away associated with the particular cell C₀, to within a predetermined factor 19. The factor 19 is chosen on the basis of the physical characteristics of the material from which the photodetector is made, and notably its metric resolution. In this example, the factor 19 is equal to 0.5 times the resolution of the photodetector.

A lower threshold 13 and an upper threshold 14 are also defined on the scale of the arrow 18, thus forming a first predetermined range of distances, consisting of:
a lower segment 16 corresponding to values of distance away that are smaller (within the limit of the threshold 13) than the distance away associated with the particular cell C0;
an upper segment 17 corresponding to values of distance away that are greater (within the limit of the threshold 14) than the distance away associated with the particular cell C0.

Additionally, in the present example, with reference to FIG. 3 again, the binary number of each environment cell C1 is encoded in two bits according to the following table:

TABLE 1

| | |
|---|---|
| Binary number | Distance away associated with |

| Bit 1 | Bit 2 | an environment cell C₁ |
|---|---|---|
| 0 | 0 | Outside the first predetermined |
| | | range of distances |
| 0 | 1 | In the lower segment 16 of the |
| | | predetermined range of distances |
| 1 | 0 | In the upper segment 17 of the |
| | | predetermined range of distances |
| 1 | 1 | In the range of equality 15 |

In the illustrative example of FIG. 3, the binary number associated with each of the environment cells C₁ has been schematically shown in each relevant cell C₁.

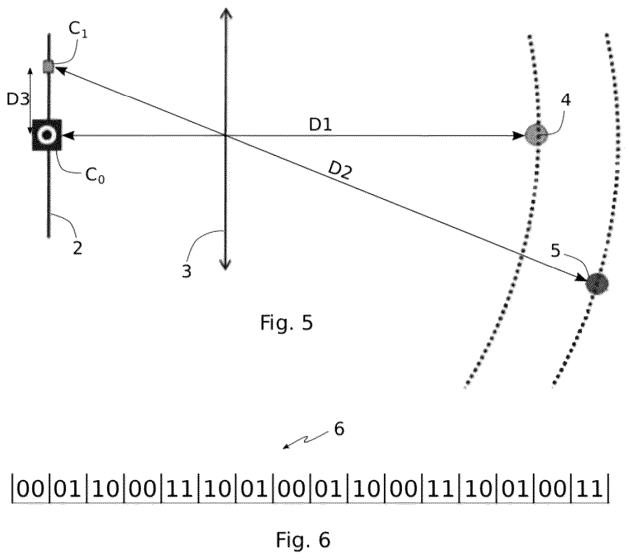

FIG. 5 schematically illustrates the criterion for determining the binary number assigned to each of the environment cells C₁ when determining a signature for a particular cell C₀. FIG. 5 illustrates the plate 2 of the photodetector (schematically shown in profile form), the optical lens 3 of the photodetector, and schematically shows the environment of the vehicle according to a simple example where two objects 4, 5 are present in the environment.

FIG. 5 schematically shows, on the plate 2 of the photodetector, the particular cell C₀ and the environment cell C₁ for which a binary number is being determined. In this example, the cell C₀ is associated with a distance away D1 corresponding to the distance between the cell C₀ and the object 4 (shown schematically by the marker 10 in FIG. 4), and the environment cell C₁ is associated with a distance away D2 corresponding to the distance between the cell C₁ and the object 5.

The cell C₁ will then have a binary number assigned to it as follows:
The binary number 00 will be assigned to the cell C₁ if the distance away D2 is greater than the threshold 14 or is smaller than the threshold 13,
The binary number 01 will be assigned to the cell C₁ if the distance away D2 is greater than the threshold 13 and is smaller than the distance D₁ decreased by the factor 19;
The binary number 10 will be assigned to the cell C₁ if the distance away D2 is smaller than the threshold 14 and is greater than the distance D1 increased by the factor 19;
The binary number 11 will be assigned to the cell C₁ if the distance away D2 is contained within the range 15, that is to say if it is substantially equal to the distance D1 (equal to the distance D1 increased or decreased by the factor 19).

The binary numbers indicated here are only an example of embodiment, and the method may evidently be used with any other binary number, starting from the moment when four different binary numbers identify the four possibilities indicated for the state of the cell C1.

Optionally, the thresholds 13 and 14 and the factor 19 can be adjusted according to the position of the cell C1 on the plate 2. In this case, the difference D2-D1 will be evaluated by weighting it with the distance D3 that separates the cell C0 from the cell C1 on the plate 2.

According to one embodiment, the method is implemented with a LIDAR device that is adapted for identifying several layers of reflected rays. These known LIDAR devices, called multi-layer LIDAR devices, allow several light rays to be acquired that are reflected on the same cell of the photodetector, for the same sequence, which allows reflection phenomena to be taken into account. For example, when the LIDAR device emits incident light rays toward a semi-reflective pane, fog, or any other element causing partial reflection of the light rays, the photodetector of the LIDAR device receives a first light ray reflected by the semi-reflecting element, then possibly receives other light rays reflected by the objects located behind the semi-reflecting element and also reflecting the incident light ray. In these multilayer LIDAR devices, each cell of the photodetector is then associated with several distances away (generally up to 4). In this case, when assigning a binary number to an environment cell C1, all the distances away associated with this cell C1 will be considered.

When a binary number has been assigned to each of the environment cells C1 of the predetermined pattern (visible in gray in FIG. 3), the method then determines a binary word that comprises all the binary numbers of all the environment cells C1 corresponding to a particular cell C0.

An example of this binary word 6 is shown in FIG. 6, this number corresponding to the example of the binary numbers assigned to each of the cells C1 in FIG. 3, read from left to right and from top to bottom. The binary word 6 illustrated in FIG. 6 is a 32 bit binary word (with the predetermined pattern provided as an example in FIG. 3 comprising 16 environment cells C1 evenly distributed around the particular cell C0). This 32 bit word 6 forms the environment signature of the particular cell C0. This 32 bit format is sufficient for generating environment signatures giving good results in the matching of the various sequences, and corresponds to a common architecture using inexpensive processors.

In the present example, the method also comprises a filtering operation (operations F1, F2 of FIG. 1), in which certain environment signatures 6 are ignored on the basis of coherence criteria. These coherence criteria are preferably simple in order to guarantee a high speed of execution of the method and low required computation resources, and in order to avoid false positives. These coherence criteria involve, for example, ignoring all the signatures 6 that comprise an abnormally high quantity of the same binary number. In the example of the 32 bit binary word 6 of FIG. 6, any signature comprising, for example, more than 24 times the same binary number 0 or the same binary number 1 will be ignored and will not be included in the set of environment signatures. The set of environment signatures thus comprises signatures 6 which also have a particular feature that is provided by the coherence criterion.

With reference to FIG. 1, during the matching step M, the set of environment signatures corresponding to a first sequence S1 is compared with the set of signatures corresponding to the second sequence S2. Each signature 6 of a sequence that is identical to a signature 6 of the other sequence will be identified as a movement from the sequence S1 to the other sequence S2.

In the matching step M, the environment signature of each particular cell C0 of a second sequence S2 is compared with all the environment signatures of the first sequence S1, that is to say the environment signature of each of the cells of the photodetector for the first sequence S1.

For this matching step M, the method uses a concept of “dissimilarity” between two environment signatures to be compared. This concept of dissimilarity is not relative to a physical distance, but rather to a concept of distance away in terms of probability that an environment signature will or will not correspond to the same object as another environment signature. Thus, a strong dissimilarity between two environment signatures will cause these two environment signatures to be considered as not corresponding to the same object from one sequence to the other, and conversely a weak dissimilarity between two environment signatures (up to a certain threshold) will cause the two environment signatures to be considered as identifying the same object in both the sequences considered.

In the present example, the total dissimilarity between two environment signatures is equal to the sum of the dissimilarities separating each binary number of the sequence considered from the binary numbers of the other sequence. Each binary number of an environment signature is therefore compared with all the binary numbers of the other environment signature, one by one, and these dissimilarities between the binary numbers are added together to result in a dissimilarity value between the two environment signatures.

According to a preferred embodiment, this concept of dissimilarity between two binary numbers is applied by assigning a dissimilarity value (the value based on the probability of matching between the binary numbers) to each possible pair. The table below illustrates an example of assignment of these values for all the possibilities of two binary numbers a and b:

TABLE 2

a

| b | 00 | 01 | 10 | 11 |
|---|---|---|---|---|
| 00 | 0 | A | A | A |
| 01 | A | 0 | B | C |
| 10 | A | B | 0 | C |
| 11 | A | C | C | 0 |

In this table, the binary number a can take the four values 00, 01, 10 and 11. The same goes for the binary number b.

A dissimilarity value of 0 is assigned to the pairs of binary numbers 00-00, 01-01, 10-10, and 11-11. This zero dissimilarity corresponds to a high probability of matching because the binary numbers compared are identical.

The other possible pairs of binary numbers are assigned a dissimilarity value of A, B or C (where A is the highest dissimilarity value and C is the lowest dissimilarity value):
the movement from a distance away outside the predetermined range of distances (between thresholds 13 and 14) to a distance away within this range is considered to be improbable. The maximum dissimilarity value A is therefore assigned to the pairs of binary numbers 00-01, 00-10, 00-11;
the movement from a distance away in the upper segment 17 of the predetermined range of distances (between thresholds 13 and 14) to the lower segment 16 of this range, or vice versa, is considered to be moderately probable. The median dissimilarity value B is therefore assigned to the pairs of binary numbers 10-01;
the movement from a distance away in one of the segments (lower 16 or upper 17) of the predetermined range of distances (between thresholds 13 and 14) to the central segment 15 of this range, or vice versa, is considered to be highly probable. The minimum dissimilarity value C is therefore assigned to the pairs of binary numbers 01-11, 10-11.

The values of A, B, and C may be calibrated for a particular application. In the present example, the values of A, B, and C are 5, 2 and 1, respectively. During the matching M, for each particular cell C₀, the dissimilarity value is calculated for each pair formed by:
the environment signature of this cell C₀ in the second sequence; and
each environment signature of each cell in the first sequence.

The pair of environment signatures showing the lowest dissimilarity value is considered to be matching. In other words, the object seen by a cell C₀ in the second sequence is considered to be the same object as that seen by another cell in the first sequence, because the pair of environment signatures has the lowest dissimilarity.

The same object can thus be identified between two sequences with a high level of operational security, using very few computing resources. Unlike other methods with low resource use, the dissimilarity computation approach also enables environment signatures to be matched even if they are not bit-to-bit identical.

Optionally, if two pairs of environment signatures have equal dissimilarity values, these values are separated on the basis of another criterion, such as luminous intensity: the cell whose luminous intensity is closest to that of the particular cell concerned will be chosen.

In the present example, the method also comprises a filtering step FM (see FIG. 1), which involves filtering, according to coherence criteria, the signatures 6 identified as present both in the sequence S1 and in the sequence S2. As previously, these coherence criteria are preferably simple. They can relate, for example, to the notion of optical flow, starting from the principle that the objects surrounding the vehicle can only move at speeds below a predetermined threshold. For example, if two identical signatures, one in sequence S1 and the other in sequence S2, are identified as relating to a movement between sequence S1 and sequence S2 that reveals a high speed, for example, at 250 km/hour, this identified match will be ignored.

In the final step C (FIG. 1), the method thus provides a filtered list of the particular cells C₀ with environment signatures 6 that are matching from one sequence S1 to the other sequence S2. The LIDAR device is thus provided with a value representing a movement in its environment.

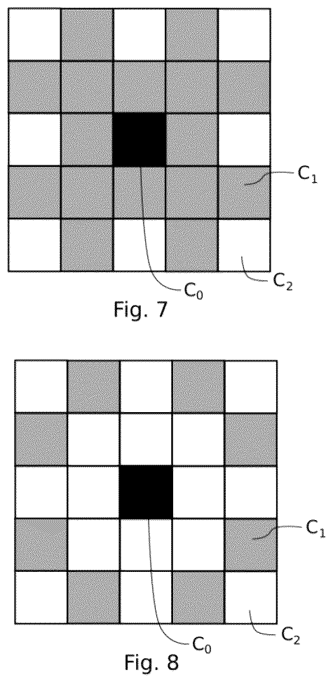

Variant embodiments of the method may be used. For example, FIGS. 7 and 8 provide two other illustrative examples of predetermined patterns that can be applied around a particular cell C₀ for determining its environment signature.

FIG. 7 illustrates a predetermined pattern returning a 32 bit binary word, yet from a different arrangement of the environment cells C₂. FIG. 8, for its part, illustrates the use of a predetermined pattern of 8 cells returning a 16 bit environment signature.

1. A method for using a light detection and ranging (LIDAR) device in a motor vehicle, the method comprising:
emitting incident light rays from the motor vehicle toward its external environment;
receiving in return reflected light rays on a photodetector of the motor vehicle;
associating a value representing a quantity relating to the reflected light ray with each cell of the photodetector that receives a reflected light ray;
a step of determining a first descriptor comprising a first set of environment signatures for a selection of cells of the photodetector, with this first descriptor corresponding to a first sequence for receiving reflected light rays;
a step of determining a second descriptor comprising a second set of environment signatures for a selection of cells of the photodetector, with this second descriptor corresponding to a second sequence for receiving reflected light rays;
a step of identifying the environment signatures that are matching in the first descriptor and the second descriptor;
an environment signature of a particular cell of the photodetector being defined as a set of distance indicators, each associated with one cell of a predetermined pattern of environment cells of said particular cell, each of said distance indicators being adapted to take a value representative of one of the following four states:
the cell concerned is associated with a distance away which is outside a first predetermined range of distances relative to the distance away that is associated with said particular cell;
the cell concerned is associated with a distance away which is located in a lower segment of said first predetermined range of distances;
the cell concerned is associated with a distance away which is located in an upper segment of said first predetermined range of distances;
the cell concerned is associated with a distance away which is substantially equal to the distance away that is associated with said particular cell, to within a predetermined factor.

2. The method as claimed in claim 1, wherein, during the step of determining the first descriptor, the selection of cells comprises only cells that are associated with a distance away; and, during the step of determining the second descriptor, the selection of cells comprises only cells that are associated with a distance away.

3. The method as claimed in claim 1, wherein the first descriptor and the second descriptor are each determined by the following operations, executed sequentially for each particular cell of the selection of cells:
a first operation of determining the environment signature of the particular cell;
an operation of adding this environment signature of the particular cell to the set of environment signatures, if the set of environment signatures does not comprise any environment signature identical to this environment signature of the particular cell;
an operation of adding this environment signature of the particular cell to the set of environment signatures, this environment signature being associated with a distinctive element, if the set of environment signatures already comprises an environment signature identical to this environment signature of the particular cell.

4. The method as claimed in claim 3, wherein said distinctive element is a value of luminous intensity relative to the particular cell.

5. The method as claimed in claim 1, wherein the predetermined pattern of environment cells, used to determine the environment signature of a particular cell, is made up of a predetermined number of cells framing this particular cell according to a predetermined pattern of a relative arrangement of the environment cells relative to the particular cell.

6. The method as claimed in claim 1, wherein the set of indicators, used to determine the environment signature of a particular cell, is formed by a set of binary numbers, each assigned to a cell of the predetermined pattern of environment cells.

7. The method as claimed in claim 6, wherein each of said binary numbers comprises two bits encoding the four values representing said indicators.

8. The method as claimed in claim 6, wherein the binary numbers are assigned to each cell of the predetermined pattern of environment cells of the particular cell, as follows:
assigning a first binary number with the environment cell if the latter is associated with a distance away that is outside said first predetermined range,
assigning a second binary number to the environment cell if the latter is associated with a distance away that is located in the lower segment of said first predetermined range;
assigning a third binary number to the environment cell if the latter is associated with a distance away that is located in the upper segment of said first predetermined range;
assigning a fourth binary number to the environment cell if the latter is associated with a distance away that is substantially equal, to within the predetermined factor, to the distance away that is associated with said particular cell.

9. The method as claimed in claim 8, wherein said predetermined value is weighted, for each environment cell, by the distance separating this environment cell from the particular cell.

10. The method as claimed in claim 8, wherein said predetermined range of distances and the predetermined factor have values, for each environment cell, that depend on the location of the particular cell on the sensor.

11. The method as claimed in claim 6, wherein the signatures of environments, each associated with a cell of the predetermined pattern of environment cells, are each arranged as a word made up of the binary numbers arranged in a predetermined order relative to the predetermined pattern of environment cells.

12. The method as claimed in claim 1, wherein, during the step of associating a value representing a quantity relating to the reflected light ray with each cell of the photodetector that receives a reflected light ray, the representative value is a distance away, with the distance away being defined as a value representing the distance between the cell and an object returning said reflected light ray.

13. The method as claimed in claim 1, further comprising a step of matching, in which each environment signature of the first descriptor is compared with each environment signature of the second descriptor.

14. The method as claimed in claim 13, wherein, in the matching step, a dissimilarity value is determined for each pair of environment signatures, the pairs of environment signatures considered to be matching being those whose dissimilarity value is lowest.

15. The method as claimed in claim 14, wherein said dissimilarity value is determined as follows:
a maximum dissimilarity value for the pairs of environment signatures comprising, on the one hand, an environment signature relating to a distance away that is outside said first predetermined range, and comprising, on the other hand, an environment signature relating to a distance away located within this first predetermined range;
a median dissimilarity value for the pairs of environment signatures comprising, on the one hand, an environment signature relating to a distance away that is located in the lower segment of the first predetermined range, and comprising, on the other hand, an environment signature relating to a distance away that is located in the upper segment of the first predetermined range;
a minimum dissimilarity value for the pairs of environment signatures comprising, on the one hand, an environment signature relating to a distance away that is located in the lower segment or in the upper segment of the first predetermined range, and comprising, on the other hand, an environment signature relating to a distance that is substantially equal to the distance away that is associated with said particular cell, to within the predetermined factor.

16. The method as claimed in claim 2, wherein the first descriptor and the second descriptor are each determined by the following operations, executed sequentially for each particular cell of the selection of cells:
a first operation of determining the environment signature of the particular cell;
an operation of adding this environment signature of the particular cell to the set of environment signatures, if the set of environment signatures does not comprise any environment signature identical to this environment signature of the particular cell;
an operation of adding this environment signature of the particular cell to the set of environment signatures, this environment signature being associated with a distinctive element, if the set of environment signatures already comprises an environment signature identical to this environment signature of the particular cell.

17. The method as claimed in claim 7, wherein the binary numbers are assigned to each cell of the predetermined pattern of environment cells of the particular cell, as follows:
assigning a first binary number with the environment cell if the latter is associated with a distance away that is outside said first predetermined range;
assigning a second binary number to the environment cell if the latter is associated with a distance away that is located in the lower segment of said first predetermined range;
assigning a third binary number to the environment cell if the latter is associated with a distance away that is located in the upper segment of said first predetermined range;
assigning a fourth binary number to the environment cell if the latter is associated with a distance away that is substantially equal, to within the predetermined factor, to the distance away that is associated with said particular cell.

18. The method as claimed in claim 9, wherein said predetermined range of distances and the predetermined factor have values, for each environment cell, that depend on the location of the particular cell on the sensor.
